(19) United States
(12) Patent Application Publication
(10) Pub. No.: US 2010/0084028 A1
(43) Pub. Date: Apr. 8, 2010

(54) Soft seat pilot-to-open check valve

(75) Inventor: Rodney Matthews, Wilmington, NC (US)

Correspondence Address: WILLIAM J. MASON;MACCORD MASON PLLC, POST OFFICE BOX 1489, WRIGHTSVILLE BEACH, NC, 28480, US

(73) Assignee: Logic Hydraulic Controls, Inc.

(21) Appl. No.: 12/287,126

(22) Filed: Oct. 6, 2008

(51) Int. Cl. F16K 15/00

(52) U.S. Cl. 137/538

(57) ABSTRACT

A pilot-to-open soft seat check valve having a soft seat and zero leakage is described. The check valve includes a valve body with a poppet bore and an annular valve seat around the bore; a poppet moveable axially between open and closed positions within the bore, the poppet having an annular valve face; a spring urging the poppet to its closed position with the annular valve face against the valve seat; an annular O-ring clamp around the bore adjacent the valve seat, the clamp including an annular O-ring channel with a radially inward open groove exposing the O-ring to the bore; and a resilient O-ring within the channel, whereby the poppet contacts the O-ring ring when the poppet is in its closed position and the O-ring is held in the O-ring channel by the O-ring clamp when the poppet is in its open position.

### BACKGROUND OF THE INVENTION

(1) Field of the Invention

The present invention relates to check valves, and in particular to pilot-to-open check valves having a soft seat and zero leakage.

(2) Description of the Prior Art

A pilot-to-open check valve includes a poppet having a face that is normally biased, e.g., by a spring, into engagement with a valve seat to allow fluid flow in only one direction through the check valve. The poppet can be moved opposite the biased direction by a fluid force external to the valve, thereby allowing fluid to flow through the valve in the opposite direction.

The poppet and valve seat are constructed of metal to create a metal-to-metal seal, or hard seat. While these valves are sometimes referred to as “zero leakage”, the reality is that these valves do leak when operated at high pressures, e.g., 5000 psi. Therefore, in the trade these valves are considered to have “zero leakage” when less than five drops of fluid per minute leaks from the pressurized valve.

Even this small amount of fluid can adversely affect operation of the equipment with which the check valve is used. Therefore, the prior art has proposed other check valves that purport to allow replacement of the metal-to-metal type check valve with a resilient elastomeric O-ring, i.e., a soft seat, with the O-ring being positioned in an annular groove and located for engagement between the poppet and the valve seat.

The O-ring is compressed into the groove when the valve is in the closed position. However, as the poppet is withdrawn from the valve seat, the O-ring is uncompressed and is subjected to extremely high shear forces due to the high pressure differential across the O-ring. As a result, the O-ring may be displaced from the groove, requiring replacement of the check valve.

Thus, there is a continuing need for a pilot-to-open check valve that achieves zero leakage with a soft seat in the form of a resilient O-ring, while still securing the O-ring in position even when the O-ring is subjected to high shear pressures during pilot opening of the valve.

### SUMMARY OF THE INVENTION

The pilot-to-open check valve of the present invention is similar in construction to conventional pilot-to-open check valves with metal-to-metal hard seats except for the components and configuration relating to mounting of a resilient O-ring to act as a soft seat around the poppet. Due to the configuration and positioning of these components, a resilient O-ring can be mounted as part of the check valve to provide a zero leakage seal when the poppet is in the closed position, while being securely retained without danger of displacement when the poppet is opened.

The pilot-to-open soft seat check valve described and claimed herein, like prior art check valves, includes a valve body with a poppet bore and an annular valve seat around the bore, a poppet with an annular valve face moveable axially between open and closed positions within the bore with the poppet valve face being biased to its closed position against an annular valve seat allowing fluid flow in a first direction, and pilot means to open the valve to permit flow in the opposite direction. In addition, the present valve includes an O-ring surrounding the poppet bore and positioned to engage the poppet head when the poppet is in the closed position.

The O-ring is held in place by an annular O-ring clamp around the bore adjacent the valve seat, the clamp including first and second annular members forming an annular O-ring channel with a radially inward open groove exposing less than 50% of the O-ring to the poppet bore, whereby the poppet contacts the O-ring when the poppet is in the closed position, with the O-ring being held in the O-ring channel by the O-ring clamp when the poppet is in the open position.

More specifically, the present pilot-to-open check valve is comprised of a pilot assembly joined to a cage assembly. These assemblies and their components are referred to herein as having proximal and distal ends or upper and lower ends for the purpose of describing the relationship and interaction of the various components. However, it will be understood that the overall orientation of the check valve is not a feature of the invention.

The pilot assembly includes a valve head of conventional design that has opposed proximal and distal ends. A piston chamber extends into the valve head from its distal end to receive a piston that is movable axially within the piston chamber. A fluid inlet extends through the valve head wall into the piston chamber. The piston has proximal and distal ends, and an axial spring recess extending inwardly from the piston distal end.

The cage assembly includes a cage that has a proximal end insertable into an axial recess in the distal end of the valve head, and a distal end. The interior of the cage includes a central bore comprised of a plurality of concentric, axially aligned bore segments of increasing diameters to be described in detail in relation to the parts that are inserted into the bore segments.

The cage also includes a poppet having a head and stem, with the stem extending through a poppet bore segment on the proximal end of the cage. The poppet head includes a cylindrical side wall and an annular valve face on its proximal side. The proximal end of the poppet stem is attached to a spring guide by a retainer. A spring is positioned between the spring guide and the proximal end of the cage to bias the poppet and the piston in the proximal direction of the check valve.

An enlarged fluid bore segment is concentric to the distal side of the poppet bore segment. Opposed fluid inlets extend tangentially through the cage wall into the fluid bore segment. A piston bore extends from the proximal end of the cage into one of the fluid inlets, with the proximal end of the piston bore being in communication with the piston chamber.

The cage also includes bore segments to receive the unique components of the present invention used to secure the O-ring in the desired location, specifically a ring bore segment is concentrically aligned with the distal side of the fluid bore segment and a retainer bore segment is concentrically aligned with the distal side of the ring bore segment. The ring bore segment is of a greater diameter than the fluid bore segment and the retainer bore segment is of a greater diameter than the ring bore segment. As a result, the ring and retainer bore segments each include proximal shoulders to retain the annular ring and the annular retainer that fit within the respective bores.

The annular ring forming one part of the O-ring clamp has a proximal side that rests against the ring bore segment shoulder and a distal side to hold the O-ring and serve as a valve seat for the poppet valve face. Specifically, the annular ring includes an axial bore having a diameter greater than the poppet stem, but less than the diameter of the poppet head. A shoulder extends from the distal face of the ring and includes a conical valve seat around the periphery of the ring bore to receive the poppet head valve face on the inner surface of the shoulder, and an angled face on the other surface of the shoulder. The outer surface of the shoulder and the distal face of the ring between the shoulder and the ring periphery serves as one side of the O-ring clamp.

The annular retainer forming the other side of the O-ring clamp has proximal and distal ends and an axial bore with a diameter greater than the diameter of the poppet head. The retainer includes an annular radially inwardly extending shoulder at the proximal end of the retainer and a proximally extending shoulder extending from the inner end of the inwardly extending shoulder. The inwardly extending shoulder has a bore approximately equal to the outer diameter of the poppet head. The distally extending shoulder includes a tapered outer wall which, with the proximal end of the retainer forms the second side of the O-ring retainer.

A resilient O-ring is clamped between the annular ring and the annular retainer when the check valve is assembled, with less than 50%, preferably from about 10 to about 30% of the O-ring wall exposed for contact by the poppet. When the poppet valve face is against the conical valve face of the annular ring, the O-ring is firmly positioned against the poppet head adjacent the interface of the poppet head and valve seat, e.g., at the interface of the poppet valve face and the poppet side wall. As a result, the O-ring provides a soft seat against the poppet head in addition to the metal-to-metal seat between the poppet head and the valve seat, thereby achieving a zero leakage check valve.

When the poppet is unseated from the valve seat to permit fluid to flow from the fluid inlets or when fluid pressure within the piston chamber acts against the spring to move the poppet in the distal direction, the poppet head moves into the retainer creating an annular fluid flow passageway around the poppet head. However, high pressure flow of fluid past the O-ring, instead of tending to unseat the O-ring, acts against the small exposed portion of the O-ring which remains clamped.

### BRIEF DESCRIPTION OF THE DRAWINGS

FIG. 1 is a sectional side view of the check valve.

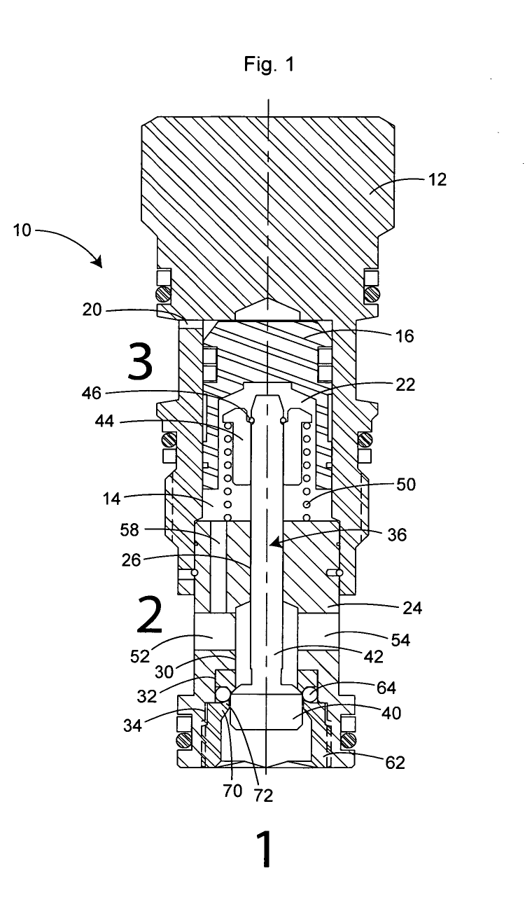

FIG. 2 is an exploded sectional side view of the check valve.

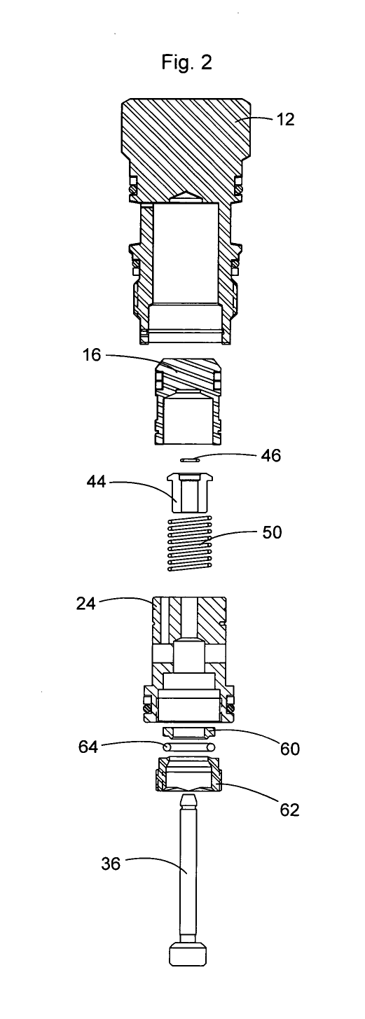

FIG. 3 is an enlarged sectional side view of the cage part of the check valve to better show the details of the O-ring and O-ring clamp.

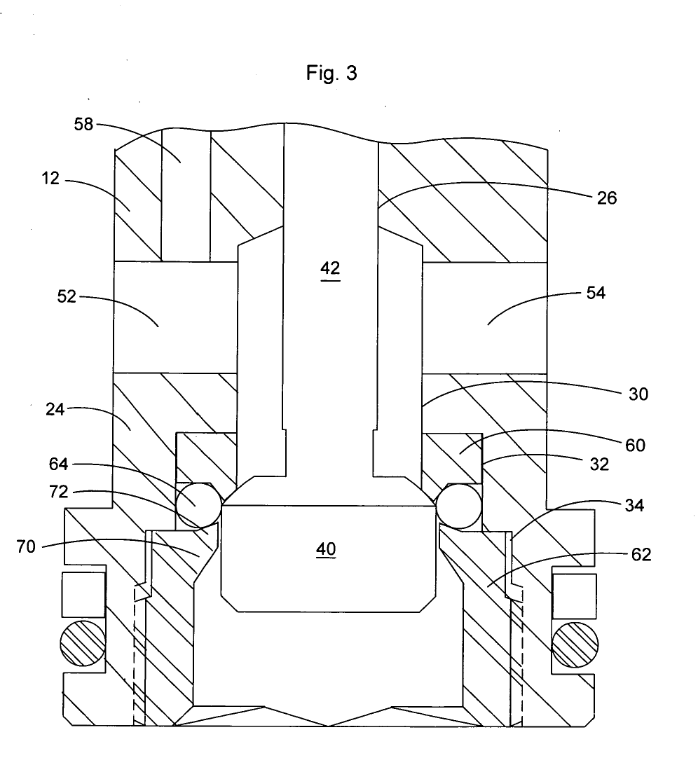

### DETAILED DESCRIPTION OF THE INVENTION

In the following description, terms such as proximal, distal, top, bottom, horizontal, upright, vertical, above, below, beneath, and the like, are used solely for the purpose of clarity in illustrating the invention, and should not be taken as words of limitation. The drawings are for the purpose of illustrating the invention and are not intended to be to scale.

A preferred embodiment of the soft seat, pilot-to-open check valve, generally 10, of the present invention is illustrated in the drawings. As described herein, the proximal end of valve 10 and its components is toward the top of the figures as illustrated, while the distal end is toward the bottom of the figures. Valve 10 is comprised of valve head 12, which includes piston chamber 14. Piston 16 is movable axially within piston chamber 14. Fluid inlet 20 extends through the wall of valve head 12 into chamber 14. Piston 16 includes axial spring recess 22.

The valve further includes cage 24, the valve body being referred to herein as the valve head and cage, that has a proximal end insertable into an axial recess in the distal end of valve head 12, and a distal end. Cage 24 includes a central or poppet bore comprised of concentric, axially aligned bore segments 26, 30, 32 and 34 having increasingly larger diameters. A poppet, generally 36, having a head 40 and stem 42, extends through the central bore. Poppet head 40 includes a cylindrical side wall and an annular valve face on its proximal side. The proximal end of poppet stem 42 is attached to spring guide 44 by retainer 46. Spring 50 is positioned between spring guide 44 and the proximal end of cage 24 to bias poppet 36 and piston 16 in the proximal direction of check valve 10.

Fluid bore segment 30 is concentric to the distal side of poppet bore 26. Opposed fluid inlets 52 and 54 extend tangentially through the wall of cage 24 into fluid bore 30. Poppet bore 58 extends from the proximal end of cage 24 into one of the fluid inlets, with the other end of the bore 58 being in communication piston chamber 14.

Cage 24 also includes ring bore segment 32 and retainer bore segment 34 to receive the unique components of the present invention to secure O-ring 56 in the desired location. Specifically, ring bore segment 32 is concentrically aligned with the distal side of fluid bore segment 30, and retainer bore segment 34 is concentrically aligned with the distal side of ring bore segment 32. Ring bore segment 32 is of a greater diameter than fluid bore segment 30 and retainer bore segment 34 is of a greater diameter than ring bore 32 segment. As a result, the ring and retainer bore segments each include proximal shoulders to retain annular ring 60 and annular retainer 62 within the respective bores segments.

The proximal side of annular ring 60 abuts against the shoulder at the interface of segments 30 and 32, while its distal side of ring 60 serves as one side of an O-ring clamp as well as a valve seat for the valve face of poppet 36. Specifically, annular ring 60 includes an axial bore having a diameter greater than the diameter of poppet stem 42, but less than the diameter of poppet head 40. A distally extending shoulder 64 surrounds the periphery of the bore of ring 60 and extends from the distal face of ring 60. The inner surface of shoulder 64 includes a conical valve seat to receive the valve face of poppet head 40. Shoulder 64 also includes an inwardly angled outer surface that in combination with the distal face of ring 60 serves as one side of the O-ring clamp.

Annular retainer 62 has proximal and distal ends and an axial bore with a diameter greater than the diameter of poppet head 40. Retainer 62 includes an annular inwardly extending shoulder 70 surrounding the bore on the proximal end of the retainer and a proximally extending shoulder 72 extending from the inner end of shoulder 70. Inwardly extending shoulder 70 has a bore 74 approximately equal to the outer diameter of poppet head 40. Shoulder 72 includes a tapered outer wall which, with the proximal end of retainer 62 forms the second side of the O-ring clamp.

O-ring 56 is clamped between annular ring 60 and annular retainer 62 when check valve 10 is assembled, with less than 50%, preferably from about 10 to about 30% of the wall of O-ring 56 being exposed for contact by poppet head 40. In the preferred embodiment illustrated, 16% of the wall is shown exposed. When the poppet valve face is against the conical valve face of ring 60, O-ring 56 is firmly positioned against poppet head 40 at the interface of the poppet valve face and the poppet side wall immediately adjacent the interface of the valve seat and face. As a result, O-ring 56 provides a soft seat against poppet head 40 in addition to the metal-to-metal seat between poppet head 40 and the valve seat of ring 60, thereby preventing leakage from the metal-to-metal seal between the poppet valve face and the valve seat, and achieving a zero leakage check valve.

When poppet 36 is unseated from the valve seat to permit fluid to flow from the fluid inlets or when fluid pressure within piston chamber 14 acts against spring 50 to move poppet 36 in the distal direction, poppet head 40 moves downwardly into retainer 62 creating an annular fluid flow passageway around poppet head 40. However, high pressure flow of fluid past O-ring 56, instead of tending to unseat O-ring 56, acts against the small exposed portion of O-ring 56, which remains clamped.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A pilot-to-open soft seat check valve comprising:
a) a valve body with a poppet bore and an annular valve seat around said bore;
b) a poppet moveable axially between open and closed positions within said bore, said poppet having an annular valve face;
c) a spring urging said poppet to its closed position with said annular valve face against said valve seat;
d) an annular O-ring clamp around said bore adjacent said valve seat, said clamp including an annular O-ring channel with a radially inward open groove exposing said O-ring to said bore; and
e) a resilient O-ring within said channel, whereby said poppet contacts said O-ring when said poppet is in its closed position and said O-ring is held in the O-ring channel by the O-ring clamp when said poppet is in its open position.

2. The check valve of claim 1, wherein less than 50% of said O-ring is contacted by said poppet.

3. The check valve of claim 1, wherein said poppet has a cylindrical side wall, said O-ring contacting said poppet at the interface of said side wall and annular valve face.

4. The check valve of claim 1, wherein 10 to about 30% of the periphery of said O-ring is contacted by said poppet.

5. The check valve of claim 1, wherein said O-ring clamp is comprised of first and second spaced clamp sections having spaced O-ring receiving channel segments that form an O-ring channel, said sections having annular bores with facing axial shoulders around said bores, said shoulder being spaced from each other at a distance less than the diameter of said O-ring when clamping said O-ring.

6. The check valve of claim 5, wherein the bore of said second clamping section has a larger diameter than the bore of said first clamping section.

7. The check valve of claim 5, wherein said annular valve seat is located on said first clamping section shoulder.

8. A pilot-to-open soft seat check valve comprising:
a) a valve body with a poppet bore;
b) a poppet moveable axially between open and closed positions within said bore, said poppet having a poppet head with an annular valve face;
c) a spring urging said poppet to its closed position with said annular valve face against said valve seat;
d) an annular O-ring clamp around said bore adjacent said valve seat, said clamp including first and second annular segments forming an annular O-ring channel with a radially inward open groove exposing said O-ring to said bore, said first clamp segment including said annular valve seat; and
e) a resilient O-ring within said channel, whereby said poppet contacts said O-ring and said valve seat when said poppet is in its closed position and said O-ring is held in the O-ring channel by the O-ring clamp when said poppet is in its open position.

9. The check valve of claim 8, wherein less than 50% of said O-ring periphery is contacted by said poppet.

10. The check valve of claim 8, wherein said poppet head has a cylindrical side wall, said O-ring contacting said poppet at the interface of said side wall and annular valve face.

11. The check valve of claim 8, wherein 10 to about 30% of the periphery of said O-ring is contacted by said poppet.

12. The check valve of claim 8, wherein said first and second spaced clamp sections having spaced O-ring receiving channel segments together forming an O-ring channel, said sections having annular bores with facing axial shoulders around said bores and spaced from each other at a distance less than the diameter of said O-ring when clamping said O-ring.

13. The check valve of claim 8, wherein the bore of said second clamping section has a larger diameter than the bore of said first clamping section.

14. A pilot to open soft seat check valve comprising:
a) a valve head with proximal and distal ends, a wall, a piston chamber extending axially inwardly from said body distal end, a fluid conduit extending through said valve body wall into said piston chamber;
b) a piston with proximal and distal ends slidable within said piston chamber, said piston including an axial spring recess extending inwardly from said piston distal end;
c) a spring within said spring recess;
d) a poppet cage having proximal and distal ends, an axial poppet conduit, a fluid conduit extending from the exterior of said cage being axially slidable within said valve body bore;
e) a poppet with proximal and distal ends, a poppet head having a conical proximal valve face, and a poppet stem extending axially from the proximal face of said poppet head, said poppet being slidable within said poppet conduit and being axially biasing to a closed position toward the proximal side of said valve by said spring;
f) an annular ring with a central bore around said poppet and an annular distally-extending shoulder around the periphery of said bore, said shoulder having a conically shaped poppet engagement valve seat and an O-ring engagement outer wall;
g) an O-ring retainer having a central bore and a proximal face spaced from said annular ring; and
h) an O-ring clamped between said ring and retainer, said O-ring being engageable through a gap between said retainer and ring by said poppet when said poppet face is in contact with said poppet engagement inner wall.

15. The check valve of claim 14, wherein less than 50% of said O-ring is contacted by said poppet.

16. The check valve of claim 14, wherein said poppet has a cylindrical side wall, said O-ring contacting said poppet at the interface of said side wall and annular valve face.

17. The check valve of claim 14, wherein 10 to about 30% of the periphery of said O-ring is contacted by said poppet.

18. The check valve of claim 14, wherein said retainer has an annular inwardly extending shoulder surrounding said retainer bore and a proximally extending shoulder extending from the inner end of said inwardly extending shoulder.

19. The check valve of claim 14, wherein said ring and retainer have annular bores with facing axial shoulders around said bores, said shoulders being spaced from each other at a distance less than the diameter of said O-ring when clamping said O-ring.

20. The check valve of claim 18, wherein the bore of said second clamping section has a larger diameter than the bore of said first clamping section.
